(19) United States
(12) Patent Application Publication
(10) Pub. No.: US 2015/0070658 A1
(43) Pub. Date: Mar. 12, 2015

(54) APPARATUS AND RELATED METHODS FOR USING LIGHT PROJECTION TO SIMULATE A SPECIFIED ENVIRONMENT

(71) Applicant: Uncle Milton Industries, Inc., Agoura Hills, CA (US)

(72) Inventors: Eric Poesch, Thousand Oaks, CA (US); Frank Adler, Oak Park, CA (US)

(73) Assignee: Uncle Milton Industries, Inc., Agoura Hills, CA (US)

(21) Appl. No.: 14/019,801

(22) Filed: Sep. 6, 2013

(51) Int. Cl. G03B 21/12

(52) U.S. Cl. CPC G03B 21/12
USPC 353/19

(57) ABSTRACT

A wall sconce provides a lighted projection on a wall which can simulate motion or an environment. The wall sconce comprises a lighting chamber having a pair of light emitting diodes (LED). The LEDs emit light which is projected through a translucent cover and projected onto a wall thereby producing a pattern. The LEDs may be turned on or off to change the angle at which light passes through the translucent cover. This change of angle causes the simulation of motion or an environment on the wall. The wall sconce comprises a speaker capable of producing sounds configured to enhance the illusion of motion or the environment on the wall. The wall sconce further comprises an integrated circuit operable to control actuation of the LEDs and the speaker. Decals may be included to enhance the experience produced by the wall sconce.

### FIELD

Various implementations of the technology disclosed herein relate to an apparatus for using light projection to simulate a specified environment. Certain of those implementations are particularly described in terms of apparatuses for simulating undersea environments, savannah or other outdoor environments, and action environments.

### BACKGROUND

It is well known that decorative sconces and other apparatuses can be used to provide illumination of enclosed spaces (e.g., the interior of rooms). Using the technology disclosed herein, one of ordinary skill in the art could provide simulations of various environments in an enclosed space using an apparatus which could be implemented using a sconce or other device suitable for mounting on walls or other surfaces in the enclosed space.

While various kinds of decorative sconces and associated components have been made and used, it is believed that no one prior to the inventor(s) has made or used the invention described in the appended claims.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 depicts an exploded perspective view of an exemplary wall sconce.

FIG. 2 depicts a front elevational view of the wall sconce of FIG. 1.

FIG. 3 depicts a side elevational view of the wall sconce of FIG. 1.

FIG. 4 depicts a top view of the wall sconce of FIG. 1.

FIG. 5 depicts a cross-sectional view of the wall sconce of FIG. 1.

FIG. 6 depicts a top view of an exemplary translucent cover.

FIG. 7A depicts a cross-sectional view of the wall sconce of FIG. 1 with a first light emitting diode (LED) emitting light through the translucent cover of FIG. 6 and a second LED off.

FIG. 7B depicts a cross-sectional view of the wall sconce of FIG. 1 with the second LED emitting light through the translucent cover of FIG. 6 with the first LED off.

FIG. 8 depicts a perspective view of an exemplary alternative translucent cover;

FIG. 9 depicts a top view of the translucent cover of FIG. 8.

FIG. 10 depicts a front elevational view of a wall sconce such as shown in FIG. 1 projecting a luminous pattern on a wall and a plurality of appliqués affixed to the wall within the luminous pattern.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown. It should be understood that the drawings are not intended to be to scale, and any dimensions provided should not be considered limiting.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

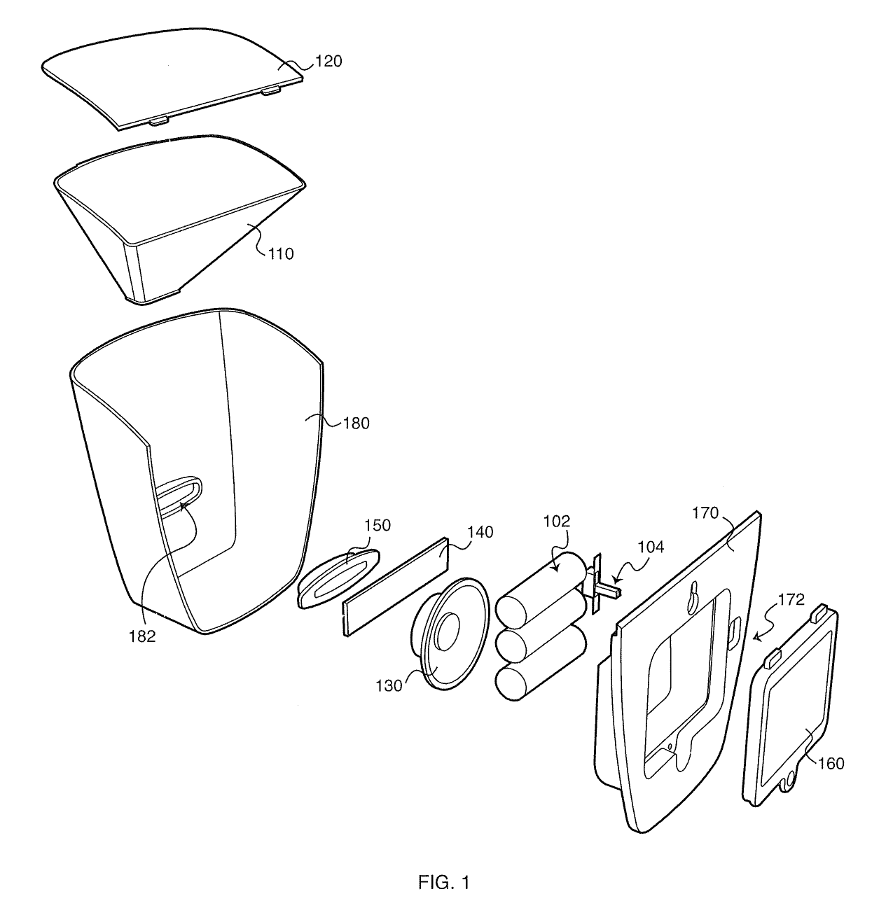

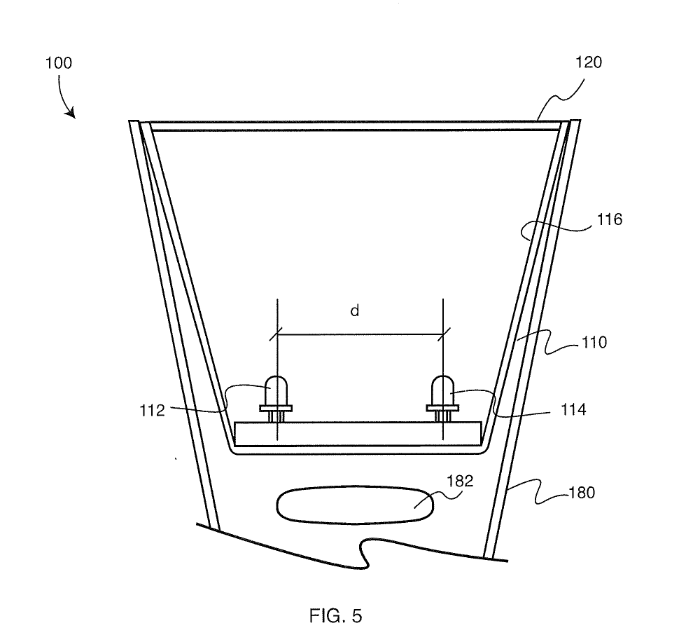

FIGS. 1-7 show an exemplary wall sconce (100) which is operable to simulate a specified environment by projecting light onto a wall to which wall sconce (100) is coupled and may also be operable to produce audio to enhance the visual experience. As shown in exploded view in FIG. 1, a wall sconce (100) implemented using the disclosed technology could include components such as a lighting chamber (110), which could be used to house one or more light sources (e.g., LEDs), a translucent cover (120), which could be coupled to or disposed above the lighting chamber (110) and through which light from the light sources would be projected, a speaker (130), through which sounds (e.g., such as could be stored in a memory element within the sconce) appropriate to the environment to be simulated could be played, and an integrated circuit (140), which could control the projection of light and playing of sound by the wall sconce (100). The exemplary wall sconce (100) shown in exploded view in FIG. 1 also includes a power source (102), a switch (104), which can be used to transition the integrated circuit (140) between operation modes (e.g., between a demo mode which activates the sconce for a short period of time to demonstrate its capabilities, and a normal operation mode which allows the sconce to operate for a longer period to provide a better simulation experience), an actuator (150), which could be used to start and stop the light and/or sound effects from the sconce (100), a cover (160), which can be used to secure the power source (102), a sconce back (170), which could be used to attach the wall sconce (100) to a wall, and a sconce body (180), which can be used to house the depicted components.

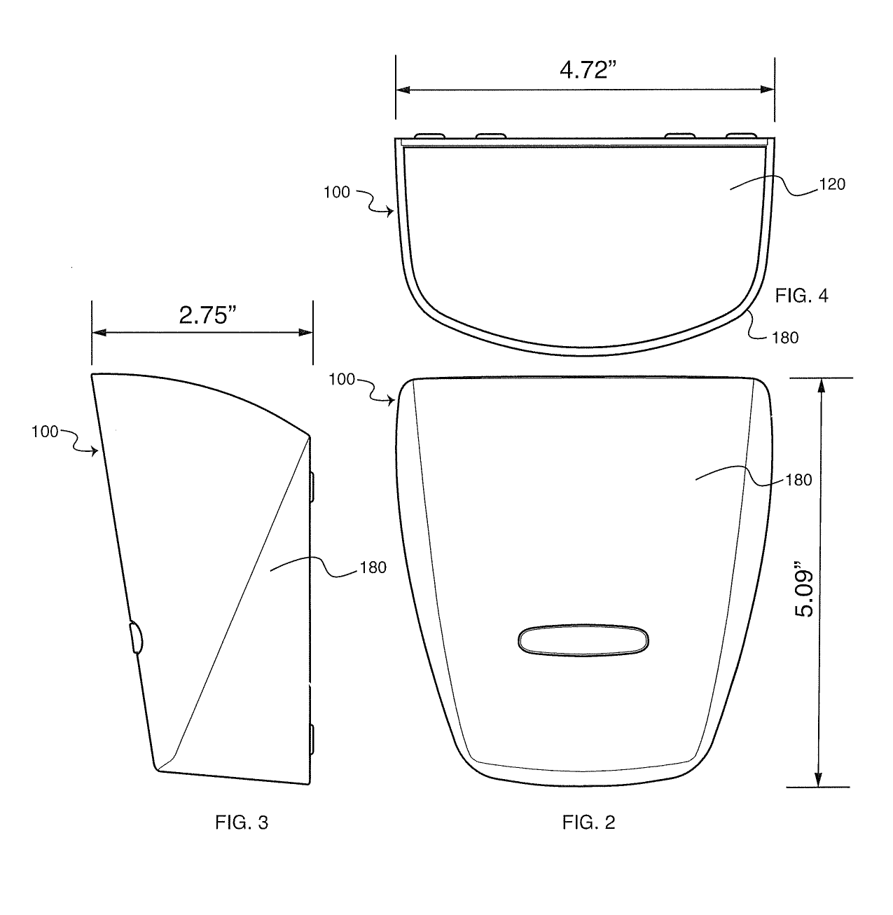

In the exemplary wall sconce (100), which is designed to be used in a space such as a child's room having a ceiling height of approximately 8 feet, the sconce body (180) has a height of 5.09 inches, a width of 4.72 inches, and a depth of 2.75 inches (these dimensions are shown in FIGS. 2-4). The translucent cover will preferably be configured to be mounted within the sconce body, and will have a back portion with a straight edge of 4.5 inches, two sides disposed at 90 degree angles to the back portion and having lengths of 1.5 inches, and a front portion with a curved edge taking the form of a semi-circle having the same radius as the length of the straight edge at the back portion. A translucent cover with such dimensions will preferably have a thickness (which may be non-uniform) of 1.8 millimeters, and a surface curvature in which the portion of the translucent cover (120) which is closest to the sconce back (160) has a deflection of 32 degrees from horizontal, and the portion of the translucent cover (120) farthest from the sconce back (160) has a deflection from horizontal of zero (or slightly less than zero) degrees. Preferably, both the sconce body (180) and the translucent cover (120) will be made of injection molded plastic, with the particular features of the plastic being determined by the intended use of the sconce. For example, in an embodiment in which the sconce is used to simulate an undersea environment, the transparent cover could be (but would not be required to be) made of transparent, blue tinted injection molded plastic, and the sconce body could be made of opaque, blue tinted injection molded plastic.

Turning now to FIG. 5, that figure shows a cross-section view of the wall sconce (100) shown in exploded view in FIG. 1. In the exemplary wall sconce (100), the light sources which would project light through the translucent cover (120) are preferably two white LEDs (112, 114), which are disposed approximately 10 millimeters from one another, and 20-25 millimeters from the translucent cover (120) (measured from the tip of the LEDs), and which would be powered by a power source (102) in the form of 3 AA batteries. To enhance the effect created by the projection of light from the LEDs through the translucent cover, the lighting chamber (110) in which the LEDs are housed would preferably be made from, or coated with, a reflective material (e.g., chrome), or a light colored material which would avoid unnecessary absorption of light. The lighting chamber, like the sconce body and the translucent cover, would preferably be made from injection molded plastic, as would the sconce's switch (104), its back (170), and its back cover (160).

In the exemplary sconce, the LEDs (112, 114) and the speaker (130) can be turned on or off using an actuator (150) accessible by a user through an opening (182) in the sconce body (180). Preferably, this actuator (150) will be implemented using a manually actuated button, though, in embodiments which include an actuator (150), the form of the actuator (150) may vary, or multiple forms of actuator (150) may be provided. For instance, actuator (150) could be implemented using a trigger, a touchpad or other type of component which could allow a user to turn off and on certain functionalities of the wall sconce (100) an integrated circuit.

It should be understood that, while certain dimensions and example components were described in the preceding paragraphs, that exemplary information is intended to be illustrative only, and should not be treated as implying limitations on manners in which the disclosed technology can be implemented. For example, although the power source (102) of the exemplary wall sconce (100) would preferably take the form of 3 AA batteries, other power sources (102) could also be used. For instance, the wall sconce (100) may receive power via an external power source (e.g. a power outlet via a cable), from a rechargeable battery pack, or from a combination of sources (e.g., a rechargeable battery pack supplemented by an external power source as needed). Variations are also possible in the dimensions described above for the exemplary sconce. For example, larger dimensions may be used to project light onto a larger surface, such as the side of a building, while smaller dimensions may be used to project light onto a smaller surface, such as the inside of a container.

Variations in the types, numbers and configurations of light sources could be used. For example, a greater number of light sources could be used in embodiments in which more subtle movement simulation and/or fine grained control of projected light. The distance between light sources could also be varied, with smaller distance being used to simulate more subtle movement, or larger distance being used to simulate more dramatic movement. Similarly, instead of white LEDs tinted light sources could be used (e.g., light sources casting blue light could be used in embodiments designed to simulate undersea environments by projecting light through an untinted translucent cover, though the use of an untinted translucent cover would not require the use of light sources casting other than white light to simulate an undersea environment).

As another example of a potential variation, although actuator (150) of the exemplary wall sconce (100) was depicted as being included in the sconce, the disclosed technology could also be used to implement sconces which receive actuation signals from external actuators (e.g., wireless or wired remote controls). Similarly, sconces implemented with the disclosed technology could rely on signals from smart phones or similar devices, or from timers or internal chronometers for activation or deactivation of light and/or sound functionality. Combinations are also possible. For example, the disclosed technology could be used to implement a sconce with light and sound functionality which could be activated by a user pushing a button once, which could be changed to light only by pushing the button again, and which could be turned off by the user pushing the button a third time or by a timer indicating that a pre-determined time period had elapsed. Additionally, as will be immediately apparent to those of ordinary skill in the art, other variations are also possible, and could be implemented by one of ordinary skill based on this disclosure without undue experimentation. Accordingly, the discussion of variations set forth above, like the disclosure which preceded it, should be understood to be illustrative only, and should not be treated as limiting.

Turning now to the operation of the exemplary wall sconce (100), in that exemplary wall sconce (100), the integrated circuit (140) is connected to the speaker (130) and is configured to cause the speaker (130) to play sounds (e.g., stored in a memory element) appropriate to the environment being simulated. Preferably, this will be a combination of thematic sounds synchronized with corresponding lighting effects to simulate a particular environment. Such thematic sounds can include either or both of include both background sounds, which the integrated circuit (140) will cause the speaker (130) to play on a continuous loop (though the particular background sounds played at any point in the loop will preferably be random to avoid the simulation becoming repetitive), and feature sounds, which the integrated circuit (140) will cause to be played in a random manner. For example, in an embodiment where the sconce is used to simulate an undersea environment, the integrated circuit (140) would preferably cause the speaker (130) to play background underwater sounds such as waves overhead on a continuous loop, and to randomly overlay feature sounds such as dolphin or whale calls.

As a complement to the connection between the integrated circuit (140) and the speaker (130), the integrated circuit (140) will also preferably be connected (e.g., through separate outputs of the integrated circuit (140), or via a circuit including the LEDs and the power source which could be broken or completed based on an output of the integrated circuit) to the LEDs (112, 114) located in the wall sconce's (100) light chamber (110). Through this connection, the LEDs will preferably be independently controllable by the integrated circuit, which will be configured to modulate the illumination provided by the LEDs (112, 114) in a manner which is synchronized with the sounds played through the speaker (130). For example, in an embodiment where the wall sconce (100) is used to simulate an undersea environment, the integrated circuit (140) could be configured to turn the individual LEDs (112, 114) on and off in time with the background sounds of waves crashing overhead, or to simulate the shadow of a whale swimming overhead by dimming the illumination of whichever LED (112, 114) is activated when a feature sound such as a whale call is played. As another example, in an embodiment where the wall sconce (100) is used to simulate an action environment, when a feature sound such as an explosion is played, the wall sconce (100) could cause the illumination provided by the LEDs (112, 114) to increase to simulate the flash that would normally accompany such a sound.

Variations on the above are also possible. For example, while control of the LEDs (112, 114) by the integrated circuit (140) was described as a complement to the sounds the integrated circuit (140) would play through the speaker (130), it is possible that the disclosed technology could be implemented in a manner which simulated an environment using programmatically controlled illumination without accompanying sound (e.g., in a wall sconce which included muting capability, or which did not include a speaker). Similarly, while the above disclosure described the integrated circuit's (140) control of the LEDs (112, 114) as being synchronized with the sounds emitted by the speaker (130), this is not a requirement for all systems which could be implemented with the disclosed technology. For example, when implementing the disclosed technology, the integrated circuit (140) could be configured to randomly generate an event, and to cause changes in light and sound associated with that event to happen at different times.

To illustrate one alternative approach to coordination of sound and light which could be implemented using the disclosed technology, consider the case of an explosion. To reflect the fact that the flash from a distant explosion would be perceived before its sound was heard, and that the sound would likely be accompanied by a shock wave, the integrated circuit (140) could be configured to simulate an explosion event by causing a brief spike in the illumination provided by the LEDs (112, 114), returning to normal operation (i.e., cycling of background sounds and illumination) for a predetermined period, then playing an explosion sound through the speaker (130) and rapidly cycling the illumination of the LEDs (112, 114) to simulate the explosion's sound and shock wave. The particular combinations of light and sound effects associated with particular events could be stored in a memory of the integrated circuit (140), and retrieved as appropriate as the integrated circuit (140) randomly generates events to be simulated. Of course, other variations are also possible, and could be implemented by those of ordinary skill in the art in light of this disclosure without undue experimentation. Accordingly, the above description should be understood as being illustrative only, and should not be treated as limiting.

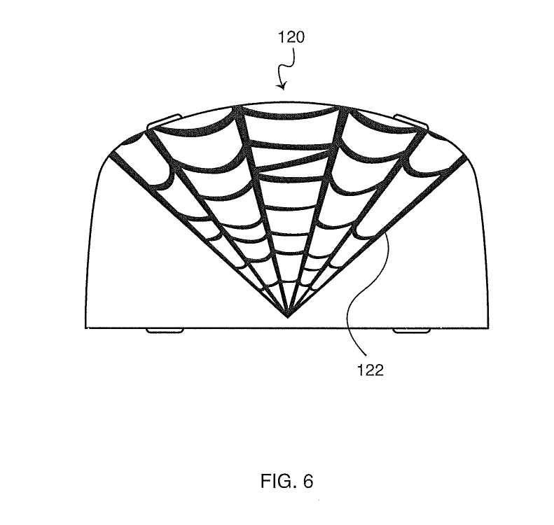

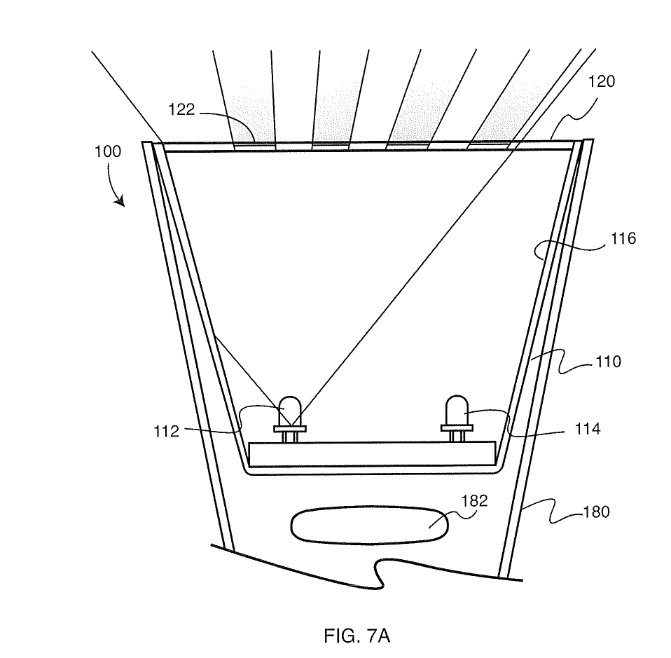

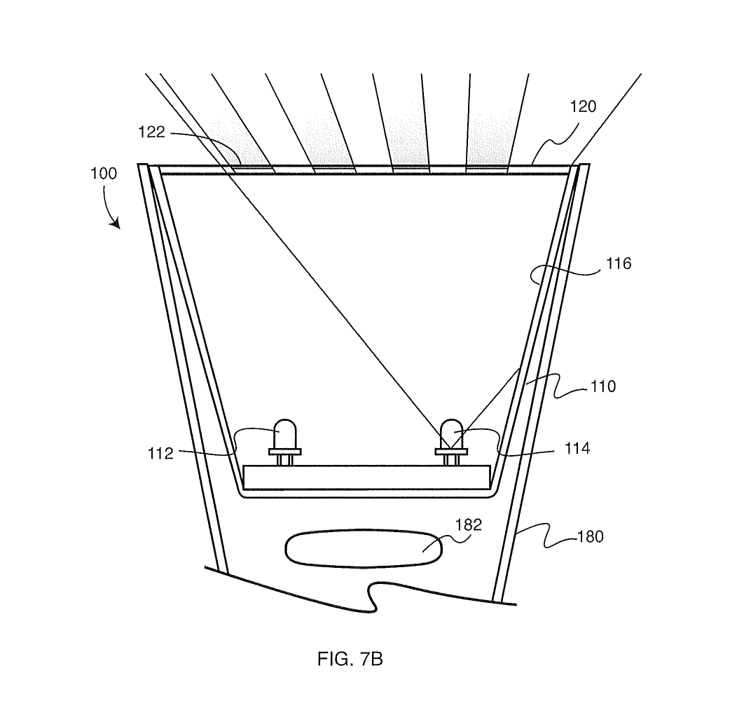

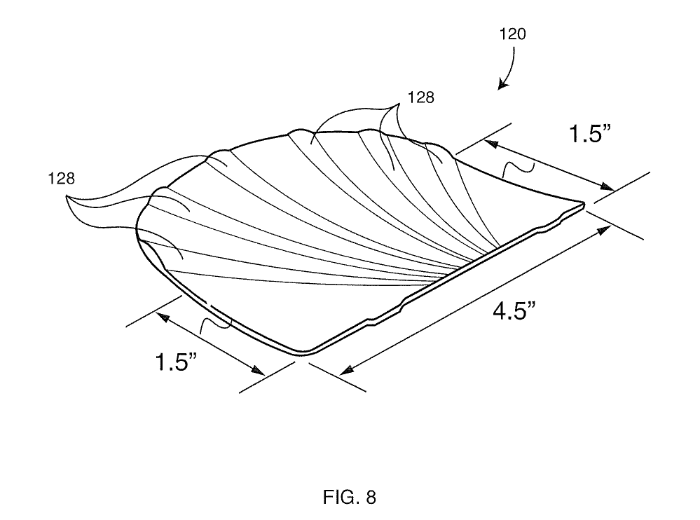

To further illustrate how the disclosed technology could use sound and corresponding light effects to simulate a specified environment, consider FIG. 6, which depicts an embodiment of a translucent cover (120) with an opaque marking (122) in the form of a spider web, and FIGS. 7A and 7B, which depict how a shadow cast by that opaque marking (122) can be made to move through the manipulation of the light projected by the LEDs (112, 114) from the wall sconce (100) as described. As light from LED (112) and second LED (114) passes through translucent cover (120), the spider web of the opaque marking (122) will be projected onto the wall. In those figures, initially, as shown in FIG. 7A, the first LED (112) is completely illuminated, while no illumination is provided from the second LED (114). Then, as shown in FIG. 7B and to simulate a discontinuous movement such as might be appropriate to an action environment, the first LED (112) is extinguished, and the second LED (114) is switched on. To heighten the effect of this transition, the integrated circuit (140) may also cause the speaker (130) to simultaneously play a web slinging sound (potentially overlaid over background city sounds such as car horns or engines).

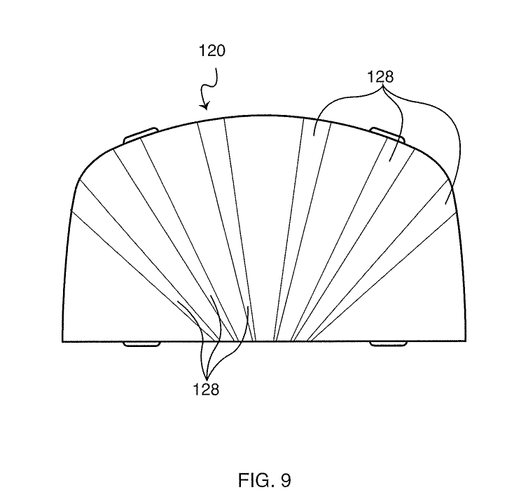

To provide yet another example of how the disclosed technology could use sound and/or light effects to simulate a specified environment, consider FIGS. 8-9, which depict an embodiment of a translucent cover (120) comprising a plurality of refracting textures which, in the embodiment of FIGS. 8 and 9, take the form of ridges (128). In the illustrated embodiment, these ridges radiate out from the middle 50% of the back edge of the translucent cover (which edge, when the cover is included in a sconce such as shown in FIG. 1 and the sconce is coupled to a wall, would be closest to the wall) to being distributed along the entire front edge of the translucent cover. Preferably, this radiation will be such that at the back of the cover, each ridge will be separated from its closest neighbor by 5 millimeters, while, at the front of the cover, each ridge will be separated from its closest neighbor by between 13 millimeters (at the portions of the curved front edge closest to the straight sides) and 20 millimeters (at the apex of the curved front edge). Preferably, this increase in separation will be accompanied by increases in the thickness and width of the ridges from the back to the front of the cover. For example, in an embodiment in which the cover has the dimensions shown in FIG. 8 and the non-ridge portions of the cover have thickness of 1.8 millimeters, the width of the ridges will preferably increase from 0.5 millimeters at the back of the cover to 7.5 millimeters at the front of the cover, and the maximum thickness of the ridges will preferably increase from 0.5 millimeters (for a total cover thickness of 1.8+0.5=2.3 millimeters) at the back of the cover to 0.7 millimeters (for a total cover thickness of 1.8+0.7=2.5 millimeters) at the front of the cover.

Of course, while the above description of FIGS. 8 and 9 provided particular measurements and configurations which could be used in a translucent cover with a non-uniform thickness, it should be understood that such measurements and configurations are intended to be illustrative only. For example, while the configuration of a translucent cover comprising radiating ridges having increasing thickness and width could be used to cause light projected through the translucent cover to simulate the rays of the sun (e.g., as might be appropriate in simulating a savannah environment), other configurations could be more appropriate for different types of simulations. For example, refracting textures in the form of ripples could be used to cause light projected through the cover to simulate an undersea environment. Other configurations suitable for simulation of other environments could also be implemented by those of ordinary skill in the art based on this disclosure, and so the examples of undersea and savannah environments should not be treated as limiting.

Similarly, while the above discussion treated the example in which a translucent cover had varying thickness independently of the example in which a translucent cover had an opaque marking, it should be understood that characteristics described with respect to those independent examples could be combined in a single embodiment. For instance, a cover having varying thickness could be included in an embodiment which provided for independent control and modulation of light emitted by LEDs (e.g., in a simulation of a savannah environment, an integrated circuit could cause one LED to brighten while the other dimmed, and vice versa, in a cycle to represent visual effects caused by intense heat). It is also possible that a cover could have both varying thickness and opaque markings. For example, a translucent cover used to simulate an undersea environment could have both varying thickness used to simulate disturbance of the water's surface, and opaque markings used to project shadows of shipwrecks or other undersea features.

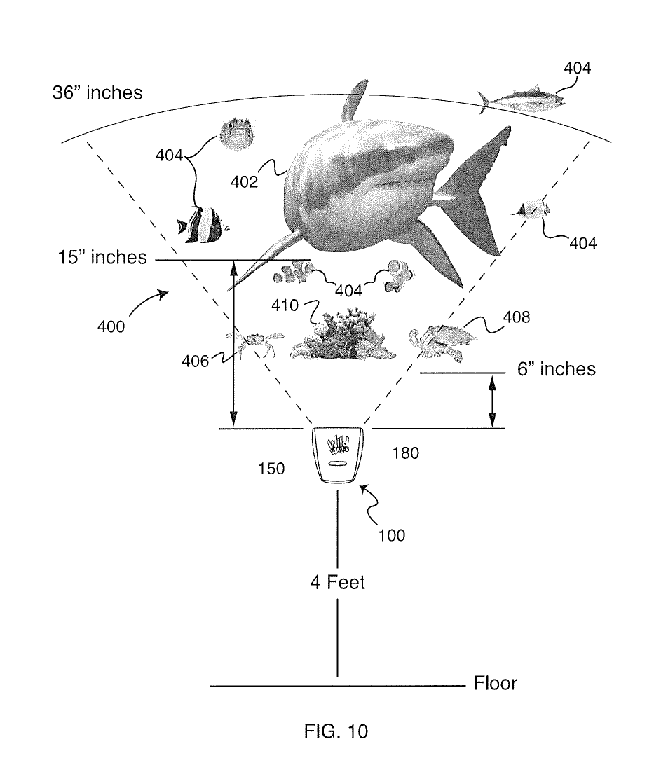

It should be appreciated that other components may be used with a sconce (100) to improve the illusion of motion or to improve the effect or environment produced by the sconce (100). For example, appliqués or decals (which could be included in a kit with which a sconce such as described could be sold) may be stuck to the wall in the area onto which light is projected. As an illustration of this, consider FIG. 10, which shows a plurality of appliqués (400) arranged on a wall in an embodiment where the sconce (100) is used to simulate an undersea environment. These appliqués (400) can include a shark (402), a plurality of smaller fish (404), a crab (406), an octopus (408), and piece of coral reef (410), though other types of appliqués (e.g., treasure chests) could be used to enhance a simulation of an undersea environment, or to enhance other types of simulation (e.g., an appliqué of a lion could be used to enhance a simulation of a savannah environment). As shown in FIG. 10, in embodiments where they are present, these appliqués will preferably be placed in a fan like pattern between 6 and 36 inches above the top of the sconce after the sconce has been affixed to a wall approximately four feet above the floor, though it should be understood that the dimensions shown in FIG. 10 are intended to be illustrative only, and that other dimensions could also be used (e.g., the sconce could be placed with its top four feet from the ceiling of a room, which could result in the distance from the floor being other than the four feet shown in FIG. 10).

While the above discussion focused on embodiments in which the disclosed technology was used to implement a light projector in the form of a sconce which could simulate various environments in an enclosed location such as a child's room, it should be understood that the technology described herein is not limited to being implemented in that manner For example, the technology described herein could be used to implement a light projector which would illuminate and simulate an environment on the side of a building. Similarly, while the above disclosure focused on embodiments of a sconce which is operable to simulate motion (e.g., wave motion for an un undersea environment) without requiring any integral moving parts, the disclosed technology could also be implemented in manners where such integral moving parts are included (e.g., were a translucent cover is moved back and forth, or tilted, or a movable lens or mirror is disposed between the light sources and the translucent cover). Accordingly, instead of limiting the protection accorded by this document, or by any related document, to the material explicitly disclosed herein, the protection should be understood to be defined by the claims, when the terms in those claims which are listed below under the label “Explicit Definitions” are given the explicit definitions set forth therein, and the remaining terms are given their broadest reasonable interpretation as shown by a general purpose dictionary. To the extent that the interpretation which would be given to the claims based on the above disclosure is in any way narrower than the interpretation which would be given based on the “Explicit Definitions” and the broadest reasonable interpretation as provided by a general purpose dictionary, the interpretation provided by the “Explicit Definitions” and broadest reasonable interpretation as provided by a general purpose dictionary shall control, and the inconsistent usage of terms in the specification or priority documents shall have no effect.

### Explicit Definitions

When used in the claims, “based on” should be understood to mean that something is determined at least in part by the thing that it is indicated as being “based on.” When something is completely determined by a thing, it will be described as being “based EXCLUSIVELY on” the thing.

When used in the claims, a “cover” should be understood as being a surface located at, or near, an exterior portion of an object.

When used in the claims, “environment” should be understood to refer to a setting, which could be an indoor or outdoor physical setting (e.g., an undersea environment, a laboratory) a cultural or social setting (e.g., an urban setting, and action setting), or a combination of such settings (e.g., an undersea action setting).

When used in the claims, “refracting texture” should be understood to refer to a feature which changes the direction of light passing through the feature. For example, a ridge on a translucent cover such as depicted in FIG. 8 could be considered a “refracting texture” because the height of the ridge would bend light passing through it, thereby changing that light's direction.

When used in the claims, “simulating” should be understood to mean reproducing or approximating one or more characteristics of the thing which is “simulated” without actually reproducing the thing being simulated. For example, a “simulated environment” could be an environment which has one or more of its characteristics reproduced (e.g., an undersea environment could be simulated through reproduction of undersea sounds, or through projection of light which moves and/or is refracted as if through water).

In light of the above, we claim:

1. A decorative sconce comprising:
a. a translucent cover disposed at a top portion of the sconce and comprising one or more features selected from the group consisting of:
i. opaque markings for a simulated environment; and
ii. refracting textures for the simulated environment;
b. a plurality of light sources disposed within the decorative sconce and independently operable by an integrated circuit to project light through the translucent cover;
c. the integrated circuit, wherein the integrated circuit is connected to the plurality of light sources and configured to make changes in light projected through the translucent cover corresponding with sounds for the simulated environment; and
d. a speaker connected to the integrated circuit, wherein the speaker is operable to play the sounds for the simulated environment under control of the integrated circuit.

2. The decorative sconce of claim 1, wherein each light source from the plurality of light sources has a distance from the translucent cover of greater than about 20 millimeters.

3. The decorative sconce of claim 2 wherein the plurality of light sources comprises a first light source having a distance of about 10 millimeters from a second light source, and wherein the plurality of light sources does not comprise a light source closer to the first light source than the second light source.

4. The decorative sconce of claim 1, wherein the translucent cover's front is curved and is disposed opposite a portion of the decorative sconce adapted to be attached to a wall.

5. The decorative sconce of claim 4 wherein the translucent cover is shaped with a deflection from horizontal increasing from the translucent cover's front to the translucent cover's rear.

6. The decorative sconce of claim 5 wherein the deflection from horizontal of the translucent cover at the translucent cover's front is about zero degrees, and wherein the deflection from horizontal of the translucent cover at the translucent cover's rear is about 32 degrees.

7. The decorative sconce of claim 1, wherein the translucent cover has a thickness between about 1.8 millimeters and about 2.5 millimeters.

8. The decorative sconce of claim 7, wherein the thickness of the translucent cover is non-uniform, and wherein the translucent cover comprises ridges having thickness between about 2.3 millimeters and about 2.5 millimeters, and wherein the translucent cover other than the ridges has thickness of about 1.8 millimeters.

9. The decorative sconce of claim 7, wherein the thickness of the translucent cover is uniform and wherein the thickness of the translucent cover is about 1.8 millimeters.

10. The decorative sconce of claim 1, wherein the translucent cover is transparent.

11. The decorative sconce of claim 10, wherein the translucent cover is tinted.

12. A method comprising:
a. using a speaker, playing sounds for an environment being simulated;
b. using a plurality of light sources, projecting light through a translucent cover of a decorative sconce, wherein the translucent cover comprises one or more features selected from the group consisting of:
i. refracting textures for the environment being simulated; and
ii. opaque markings for the environment being simulated; and
c. using an integrated circuit configured to cause sounds for the environment being simulated to be played through a speaker, causing the two or more light sources to make changes in the light projected through the translucent cover corresponding with the sounds for the environment being simulated.

13. The method of claim 12, wherein the integrated circuit is configured to control the playing of sounds for the environment being simulated by playing one or more background sounds on a continuous random basis and playing one or more feature sounds on an intermittent random basis.

14. The method of claim 13, wherein the integrated circuit is configured to simulate continuous movement by smoothly increasing and decreasing light emitted by individual light sources and to simulate discontinuous movement by switching between individual light sources.

15. A kit comprising:
a. a plurality of appliqués depicting objects in an environment to be simulated;
b. a decorative sconce, the decorative sconce comprising an integrated circuit connected to a plurality of light sources and configured to independently control the individual light sources from the plurality of light sources and to make changes in light projected by the light sources, the changes corresponding to sounds for the environment to be simulated;
wherein the decorative sconce further comprises a translucent cover disposed above the plurality of light sources and comprising one or more features selected from the group consisting of:
i. opaque markings for the environment to be simulated; and
ii. refracting textures for the environment to be simulated;
wherein the decorative sconce further comprises a speaker connected to the integrated circuit and operable to play sounds for the environment to be simulated under control of the integrated circuit.

16. The kit of claim 15, wherein the decorative sconce, and each appliqué from the plurality of appliqués, are adapted to be attached to a wall.

17. The kit of claim 15, wherein the translucent cover comprises an opaque marking and does not comprise refracting textures, and wherein the opaque marking comprises a sticker applied to the translucent cover.

18. The kit of claim 15, wherein the translucent cover comprises refracting textures and does not comprise opaque markings, and wherein the refracting textures comprise a plurality of ridges.

19. The kit of claim 18, wherein each ridge from the plurality of ridges extends from the translucent cover's front to the translucent cover's rear, and has a width which increases from the translucent cover's rear to the translucent cover's front, and has a thickness which increases from the translucent cover's rear to the translucent cover's front.

20. The kit of claim 19, wherein each ridge from the plurality of ridges has a separation from the nearest other ridge which increases from the translucent cover's rear to the translucent cover's front.
